(19) United States
(12) Patent Application Publication
(10) Pub. No.: US 2026/0159650 A1
(43) Pub. Date: Jun. 11, 2026

(54) Water-based epoxidized lignin and process for its production and its use as phenol-formaldehyde replacement in adhesives and cross-linkers

(71) Applicant: Aalto University Foundation sr, Aalto (FI)

(72) Inventors: Rahul Prasad Bangalore Ashok, Aalto (FI); Nina Forsman, Aalto (FI); Susanna Forssell, Aalto (FI); Alexander Henn, Aalto (FI); Elham Khalati, Aalto (FI); Pekka Oinas, Aalto (FI); Monika Österberg, Aalto (FI)

(21) Appl. No.: 18/709,537

(22) PCT Filed: Nov. 9, 2022
(86) PCT No.: PCT/FI2022/050740

§ 371 Date: May 13, 2024

(30) Foreign Application Priority Data
Nov. 12, 2021 (FI) 20217173

(51) Int. Cl. C08H 7/00

(52) U.S. Cl. CPC C08H 6/00

(57) ABSTRACT

The invention is the synthesis and use of epoxidized lignin (EL) preferably with but also without colloidal lignin nanoparticles (CLP, plural CLPs). The invention is divided in two parts, synthesis and utilization. The synthesis of the invention is performed in the following general steps:
Preparation of an aqueous solution of lignin and a base.
Combining the lignin solution with epichlorohydrin at 1-90° C., where the amount of epichlorohydrin should be within 1-20 ml per gram of lignin.
Allowing the epoxidation reaction to take place between 1 minutes to 5 hours, while stirring the mixture.
Removal of excess epichlorohydrin from epoxidized lignin solution by e.g. solvent extraction.

EL functions as a cross-linker and may be used e.g. to prepare adhesives, surface coatings, and composite materials. EL may also be used as foaming agent in water-based solutions.

### BACKGROUND OF THE INVENTION

### Field of the Invention

The invention belongs to the field of materials suitable for use in wood products for construction and furniture, with some focus on wood panels like plywood or plyboard. The invention is mainly designed to provide use as adhesive for plywood and hardwood manufacture but can also provide use as adhesives for other materials, such as glass, metal and concrete, or as a surface coating for said materials. The material of the invention can also be used to increase the strength of composites.

When cured, the material of the invention forms a hard solid, which creates a strong adhesion onto its substrate that can be compared to available adhesives and coatings. The material is resistant to water and non-reactive solvents, e.g., acetone, tetrahydrofuran (THF), ethanol, and more. The invention is also resistant to alkaline and acidic aqueous media. Furthermore, the adhesive resists incineration at over 700° C. in oxygen. The material of the invention, in contrast to most other available similar items, does not contain any formaldehyde or other volatile reactive agents.

Due to safety reasons the invention is better suited for the manufacture of wood panels used indoors in houses (e.g. floors, walls, roofs) and furniture than other competing inventions that release formaldehyde into the air. Containing over 80% lignin, the material of the invention is contributing to the United Nation's sustainable development goals by both creating a valuable application for lignin, an abundant natural raw material, available as a side stream, whose production does not compete with food, and by utilizing renewable raw materials instead of fossil-based ones. The invention can be made using only bioderived materials if so desired.

The lignin used in the invention can come from multiple sources and may be isolated using various processes (e.g., kraft, organosolv, and enzymatic processes), but preferably one that retains its hydroxyl groups.

### Description of Related Art

The plywood adhesive industry is currently largely relying on formaldehyde as cross-linker for phenol, urea, and melamine. Alternatives to formaldehyde-based adhesives are increasingly sought after due to their toxicity (especially formaldehyde and melamine) but also because of their fossil-based origins (Rafiqul I. et al. 2005; Gentry JC 2007). Climate change is pushing industries towards technologies with small carbon footprints, which functional biomaterials may possess (Bastin J F. et al. 2019). Most biomaterials (such as proteins or polysaccharides) are water-soluble or hydrophilic which results in poor wet bonding strength (Heinrich L A. 2019). Lignin, a water-insoluble polyaromatic macromolecule originating from lignocellulosic biomass has nevertheless been used by plywood manufacturers as a polyphenolic filler to decrease raw-material costs since before the 1940's (U.S. Pat. Nos. 2,168,160 A; 1,886,353 A). Lignin is produced as a side product in pulp and paper and biorefinery industries in huge amounts annually, but still has not any relevant applications. It is estimated that only around 2% of the isolated lignin is used in solid applications while the rest is incinerated for energy recovery in pulp mills (Kai D. et al. 2016).

Although lignin is used in the plywood industry it often decreases the adhesive's performance (U.S. Pat. No. 3,658,638 A). While lignin can replace a certain amount of the phenol (US 20200040022 A1), for example, it cannot replace formaldehyde as it functions as cross-linker (U.S. Pat. Nos. 3,658,638 A; 5,202,403 A). The formaldehyde therefore remains a problem also in lignin-containing resins. In modern lignin-containing adhesives the lignin may first be modified by phenolation to increase its reactivity with formaldehyde (US 20200040022 A1; Kalami S. et al. 2017). While this strategy has shown better adhesive performance compared to earlier versions, the biomaterial content is moderate but the formaldehyde content cannot be decreased by more than a few percent (US 20200040022 A1; U.S. Pat. No. 5,866,642 A).

The renewable raw-material content of lignin-based adhesives is significantly higher than traditional ones, but nevertheless the toxic effects of formaldehyde should be addressed, as formaldehyde fumes can be released from wood panels such as plywood and plyboards even after being cured. Studies have shown that (most) people, especially those working in fields like resin manufacture or firefighting, are exposed to significant levels of formaldehyde on a daily basis (Kim K H, et al. 2011; Jurvelin J A, et al. 2003) and that the inhalation of formaldehyde fumes can lead to conditions such as asthma and cancer (Kurttio P. et al. 1993; McGwin G. et al. 2010). Because concrete is increasingly being replaced by wood as a building material to reduce carbon dioxide emissions (Saul Elbein 2020; Salazar J. et al. 2009; Internet article by YIT Corporation, 2021), an increased use of plywood in walls, floors and roofs is likely (Salazar J. et al. 2009). The health problems accompanied by formaldehyde fumes should be solved to make the transition to wood-based construction materials safer. New solutions should also be bio-based to guarantee prolonged relevance.

Epoxies have gained increasing attention as alternative to formaldehyde. For example, US20150329753A1 discloses the use of glycerol diglycidyl ether (GDE) and lignin for the preparation of plywood with good mechanical properties (Qian Y. et al. 2015). However, lignin epoxidation strategies have been developed for years and have shown useful for forming lignin-based cross-linkers. Lignin epoxidation is generally done by reacting lignin with epichlorohydrin under highly alkaline conditions (FIG. 3a) (Malutan T. et al. 2008; Asada C. et al. 2015; Sasaki C. et al. 2013; Ferdosian F. et al. 2014). Lignin is usually first dissolved in an aqueous solution of sodium hydroxide to which epichlorohydrin is added, or the other way around. Excessive amounts of epichlorohydrin are often used to minimize the risk of self-polymerization. Alternatively, lignin can be dissolved completely in epichlorohydrin whereafter sodium hydroxide is added, but this strategy requires fractionation to isolate the epichlorohydrin-soluble lignin (Asada C. et al. 2015). Lignin can also be dissolved in non-volatile solvents such as dimethylformamide or dimethyl sulfoxide (WO2015044893A1; Jablonskis A. et al. 2018). Reported reaction times for all of these methods have been around 1-14 hours at 60° C. or above. There is often one solid product that accompanies the desired runny, or gel-like epoxidized lignin (Malutan T. et al. 2008; Sasaki C. et al. 2013; Jablonskis A. et al. 2018;Ferdosian F. et al. 2012). Solid epoxidized lignin is an indication of significant homopolymerization (Malutan T. et al. 2008; Ferdosian F. et al. 2012). The potential applications of solid epoxidized lignin are limited as it is difficult to spread. Therefore, the yield of the usable product decreases if solid epoxidized lignin is produced in the reaction. In addition, the fractionation step ultimately makes the overall process more expensive and thereby removes one of the main benefits of using lignin as raw material. Long reaction times at relatively high temperatures is also problematic because it results in a substantial energy consumption.

Some prior patents disclose similar ideas. For example, CN110343496A discloses a method for epoxidizing lignin in a polyol mixture (CN110343496A). The invention would be used in polyurethane adhesives. This approach nevertheless requires catalyst and reaction times from 1-2 hours and contains rather significant amounts of fossil-based chemicals. In addition, amine-compounds are used as curing agents. CN112126391A discloses a method for the oleylation of and subsequent epoxidation of lignin, for increased water-resistance (CN112126391A). The curing and epoxidation of this approach nevertheless require several hours, followed by a curing reaction which also preferably requires at least 2 h at 80-100° C. Also here, the resin is cured by amine compounds. JP2012236811A discloses a method for the epoxidation of the methanol soluble fraction of gramineous plant lignin (JP2012236811A). This method uses both fractionation and several hours at elevated temperatures during the epoxidation, which is also conducted in the presence of a phase transfer catalyst. This method, however, describes the use of lignin as hardener. Henn, KA. et al. (2020) disclosed the use of lignin particles as a precursor for the preparation of aqueous epoxidized lignin. The method did not require fractionation and produced an epoxidized lignin that could be used for strong adhesives in only a 30-minute reaction. However, the concentration of the final product in this method was low, and the neutralization required to stop the reaction produced a large amount of salt that not only poses a challenge due to corrosion, but also creates a need for thorough purification of the product. The process also produced a solid fraction, that cannot be used effectively for adhesives due to its poor spreadability.

The prior art previously presented does not embody the synthesis of water-soluble epoxidized lignin through a process that generally obeys the following guidelines:
1) Requiring no lignin-fractionation or post isolation processing (such as depolymerization) after isolation (by chemical pulping processes such as the kraft or organosolv process) for success.
2) Temperature upheld mostly using heat provided by the reaction itself.
3) Using temperatures below 90° C., preferably below 60° C.
4) Using short reaction times (3 minutes-10 hours, preferably 8-30 minutes).
5) High recyclability of the excess epichlorohydrin.
6) Requiring no acid precipitation to stop reaction, and thus results in minimal formation of NaCl.
7) Resulting in mostly or fully a water-soluble or gel-like epoxidized lignin (product).
8) Resulting in a product-concentration of above 20 wt. % (if so desired) without distillation of water or epichlorohydrin.
9) Resulting in an adjustable hydroxyl-to-epoxy conversion.
10) Resulting in a product that may function both with and without the addition of a curing agent by adjusting the temperature and reaction time within the limits of point 3 and 4.

The process of the invention presented herein is therefore both novel and valuable as it enables a broader use of lignin without harsh and expensive processing that would remove its value as a sustainable raw material. In the case of a high hydroxyl-to-epoxy conversion, a curing agent is needed to enable polymerization. Hydroxyl groups in lignin (especially phenolic) may react with epoxy groups, making lignin itself a suitable curing agent. A challenge regarding the use of lignin for said purpose is lignin's poor water solubility, generally demanding the use of organic or alkaline solvents. Colloidal lignin particles (CLPs) may be evenly dispersed in water and can therefore solve this problem. No prior art describes the use of colloidal lignin particles together with any kind of epoxidized lignin for plywood adhesives. Epoxidized lignin, produced as here described, can also be used as a cross-linker in phenol-formaldehyde adhesives and replace part of the formaldehyde.

### SUMMARY OF THE INVENTION

The invention is defined by the features of the independent claims. Some specific embodiments are defined in the dependent claims.

According to a first aspect of the present invention, there is provided a process for synthesising epoxidized lignin (EL).

According to a second aspect of the present invention, there is provided the use of the epoxidized lignin synthesized as described herein for adhesives, for composites, coatings, or as a general cross-linker.

The invention is the synthesis and use of epoxidized lignin (abbreviated EL) preferably with but also without colloidal lignin nanoparticles (abbreviated CLP, plural CLPs). The invention is divided in two parts, synthesis and utilization. In a preferred embodiment, both parts require low amounts of fossil-based chemicals and low amounts of energy, are easy to prepare, and are highly bio-based, preferably highly lignin-based.

The synthesis of the epoxidized lignin (EL) of the invention is performed in the following general steps:
Preparation of an aqueous solution of lignin and a base. For example, 10-20 wt. % lignin in 0.1-2 M NaOH.
Combining the lignin solution with epichlorohydrin at 1-90° C., preferably at 35-55° C. The amount of epichlorohydrin should be within 1-20 ml, preferably 4-8 ml, per gram of lignin.
Allowing the epoxidation reaction to take place between 1 minutes to 5 hours, preferably 5-30 minutes, more preferably 8-15 minutes, while stirring the mixture. The temperature is allowed to increase to up to 90° C., preferably only to temperatures between 45-60° C.
Removal of excess epichlorohydrin from epoxidized lignin solution by e.g. solvent extraction. This step may require cooling, depending on which solvent is used for extraction. Pentane is a particularly suitable solvent, but other water-insoluble solvents may be used as well.
Separation of EL from the aqueous solution. This may be done using an ultrafilter or by precipitation by the addition of an organic solvent, such as acetone. The added volume to cause precipitation may depend on the solvent.
Optionally EL is washed using water or an organic solvent in an ultrafilter or by decanting, before proceeding to solvent exchange trough e.g. ultrafiltration. NaOH can be recovered from the washed solution, and the pH of the product can be lowered by solvent exchange or acid neutralization if desired.
Optionally EL can be diluted with water or dried in ambient conditions or under reduced pressure with some heating.

EL is water-soluble before curing. The solubility depends partly on the degree of self-polymerization. A high degree of self-polymerization results in increased viscosity and reduces the solubility in water. In a preferred embodiment, the EL is fully water soluble. The consistency and solubility can be altered by adjusting the lignin concentration, reaction temperatures and/or reaction time.

EL functions as a cross-linker and may be used e.g. to prepare adhesives, surface coatings, and composite materials. EL may also be used as foaming agent in water-based solutions. The epoxidized lignin can react with substances that function as hardeners. Hardeners are here defined as substances that have one or more chemical groups that can react and link with epoxy groups (also known as oxirane groups). In polymer mixtures containing hardeners, the EL covalently link these groups and form larger covalently linked composite polymers. Examples of hardeners are amines (such as diethylenetriamine, triethylenetetramine, tetraethylenepentamine, N-aminoethylpiperazine, etc.), polyols (preferably phenolic ones, such as lignin, bisphenol-A, novolacs, etc), or various thiols.

EL can, depending on the conversion, function as its own hardener. The conversion depends on the reaction time, the temperature, and the amount of base and epichlorohydrin. EL can consequently be used alone or in mixtures with hardeners and other agents, such as unmodified lignin, or CLPs and polymer matrices, such as polylactic acid, polyethylene, polyethylene terephthalate, polyvinyl chloride, polypropylene, polystyrene, phenol-formaldehyde, and others of the likes. Both thermoplastic and thermosetting polymer blends can be used as co-ingredients. The use of plasticizers, such as low molecular weight polymers, may be used to decrease brittleness and increase flexibility. The possibility of using EL as its own hardener provides a higher degree of simplicity and customization in the design of the adhesive. It nevertheless requires either a lower substitution or a higher amount of NaOH in the adhesive to catalyze the reaction. Because the most reactive hydroxyl groups in lignin readily react with epichlorohydrin, achieving a low degree of substitution may, depending on the lignin source, require greater control of the reaction compared to achieving a high degree of substitution. Using CLPs together with EL decreases the ratio of non-lignin substances, such as NaOH, in addition to increasing thermal stability and also strength. The CLPs can act both as hardener and particulate reinforcing agent, thus providing multiple benefits.

The lignin used to prepare EL and CLPs may originate from various sources and may be isolated using various processes. Preferably, the lignin should contain more than 4 mmol/g hydroxyl groups of which preferably at least 1 mmol/g are phenolic ones. EL may be used to create hybrid CLPs together with unmodified lignin, e.g. following the method of Sipponen et al. (2020). The preparation of CLPs is preferably done following the method described in WO2019081819A1, but can also be done using a variety of other methods. EL can also be precipitated into epoxidized CLPs, or be used as a co-ingredient for hybrid epoxidized CLPs.

The utilization of EL together with CLPs enables a high content of bio-based materials and enables the invention to be embodied as a fully water-based product even at slightly acidic pH. Commercial amine-based hardeners are effective curing agents but have a strong unpleasant smell and are not necessarily bio-based. Another important aspect is the use of EL as cross-linker for phenol-formaldehyde resins. The material may be embodied as an adhesive or as a thermosetting composite. In such embodiments EL can decrease the amount of formaldehyde that would otherwise be needed by contributing to the polymerization. There are currently only a few available alternatives to this formaldehyde, especially in the adhesive industry. When cured, the material is fully insoluble and highly heat resistant. The material may also be embodied as a surface coating. EL-based embodiments may possess lignin's properties, such as UV-absorption, antioxidant activity, and resistance to microbial degradation. These properties may be useful in all mentioned embodiments.

The main benefits that the invention provides in its embodiments is the reduced use of hazardous chemicals and volatile organic compounds. In all embodiments, the invention promotes the use of lignin, which is an abundant raw material that is very underutilized. By applying lignin more widely, the invention may help to reduce the carbon dioxide emissions from burning lignin, decrease the use of fossil raw materials, and increase the value of lignin.

### BRIEF DESCRIPTION OF THE DRAWINGS

FIG. 1. shows the chemical reaction between hydroxyl groups in lignin and epichlorohydrin in alkaline conditions. The figure also shows FT-IR, ³¹P- and ¹H-NMR data showing the presence of epoxide groups and the reduced number of hydroxyl groups, which is evidence of a successful epoxidation reaction. Particularly, FIG. 1 shows the synthesis and characterization, and appearance of epoxidized kraft lignin (EKL). FIG. 1 (a) Reaction scheme between a phenolic lignin-structure and epichlorohydrin. FIG. 1 (b) FTIR spectra of EKL and kraft lignin (KL). FIG. 1 (c, f, g) ¹H-NMR and (d) ³¹P-NMR spectra of EKL and KL spectra of EKL and KL. FIG. 1 (e) appearance of EKL.

FIG. 2. shows FT-IR spectra of EL stopped by solvent exchange and acid neutralization. The figure also shows the FT-IR spectra of clean and solvent extracted epichlorohydrin, indicating successful recovery of epichlorohydrin using pentane extraction. Particularly, FIG. 2 shows reaction stopping mechanisms by removal of epichlorohydrin and neutralization. FIG. 2 a&b. Purity of epichlorohydrin after extraction compared to pure epichlorohydrin and pentane analyzed by FTIR. FIG. 2 c&d. FTIR spectra of EKL when stopped by acid precipitation and solvent exchange. The spectra were normalized between (a-c) 4000-600 cm⁻¹ and (d) 1025-880 cm⁻¹.

FIG. 3. shows the synthesis of EL in laboratory scale, particularly by using epichlorohydrin (EPC) and a 10 wt. % lignin solution dissolved in ca. 1 M NaOH.

FIG. 4. shows the change in temperature when a 10 wt. % lignin solution is added to epichlorohydrin in small fractions. Particularly, FIG. 4 shows the heat change of reaction beaker insulated with plastic foam as an aqueous solution of 1 M NaOH and 10 wt. % lignin is added to 7 ml epichlorohydrin. One addition of 1 ml was done each minute. The temperature of the lignin solution was 23° C.

FIG. 5. shows the appearance and molar mass distributions of EL produced with different initial lignin concentrations, particularly of unmodified kraft lignin and different epoxidized kraft lignin (EKL) samples. The figure shows how the degree of self-polymerization is affected by lignin's concentration. The figure also shows the respective appearances of dried EL under a light microscope. FIG. 5 (a) The molar mass distributions of unmodified kraft lignin and the three EKL samples according to HPLC measurements. FIG. 5 (b) The appearance of the tested solutions after filtration. FIG. 5 (c) Light microscopy images of the EKL samples.

FIG. 6. shows the adhesive strength of EL and CLPs in different ratios. The figure also shows the effect of adhesive spread, curing temperature, and curing time. The figure also presents the wet strength of EL adhesives. Particularly, FIG. 6 shows the adhesive strength of epoxidized lignin hardened with CLPs. FIG. 6 (a) The effect of different EKL:CLP mass ratios on adhesive strength and a commercial epoxy adhesive. Samples hot pressed at 145° C. and for 5 minutes. FIG. 6 (b) The dry and wet strength of the EKL+CLP and EKL adhesive with the adhesive mass 150 g/m² hot pressed at 145° C. and for 5 minutes. FIG. 6 (c) The effect of particle size on EKL+CLP adhesives pressed at 145° C. for fem minutes. FIG. 6 (d) The effect of hot press temperature and time, and adhesive dry mass (on 1 cm²) on shear strength (in MPa) using the EKL:CLP ratio 1:1 calculated by MODDE. All samples were pressed at 1.1 MPa

FIG. 7. shows the heat resistance of cured EL materials, particularly the thermal resistance of cured and uncured EKLs compared to lignin and a commercial epoxy. FIGS. 7 (a) TGA and (b) DTG curves of cured EKL+CLP composite, uncured EKL, and unmodified kraft lignin (KL). FIG. 7 (c) DSC thermograms of cured and uncured EKL+CLP mixtures and KL. FIG. 7 (d) Fire resistance of EKL+CLP mixture, showing inability of EKL+CLP to burn in contrast to the wood.

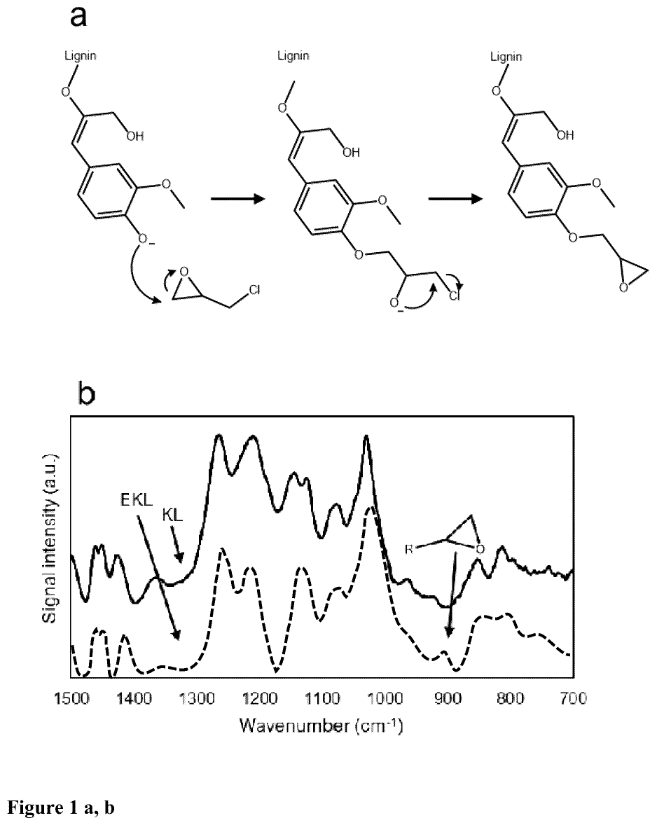

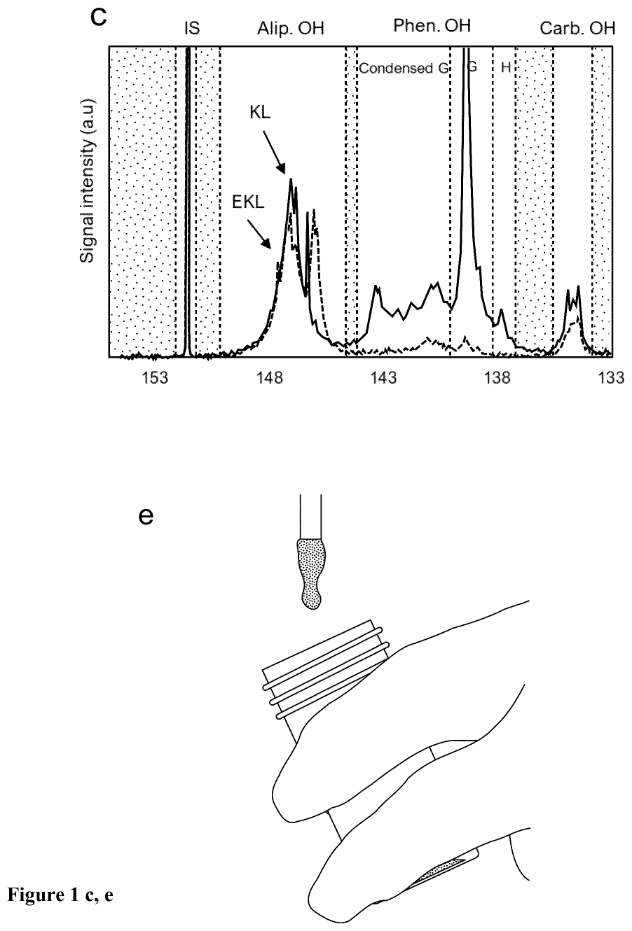

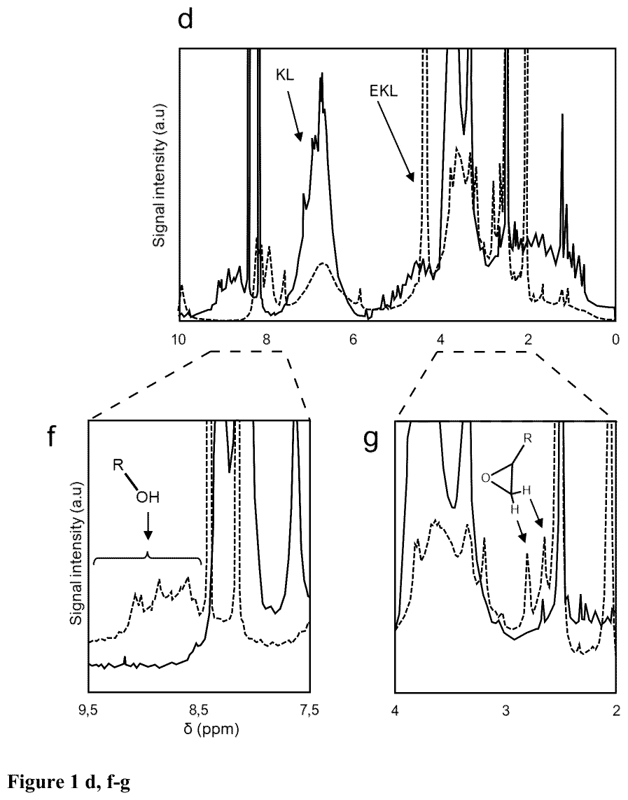

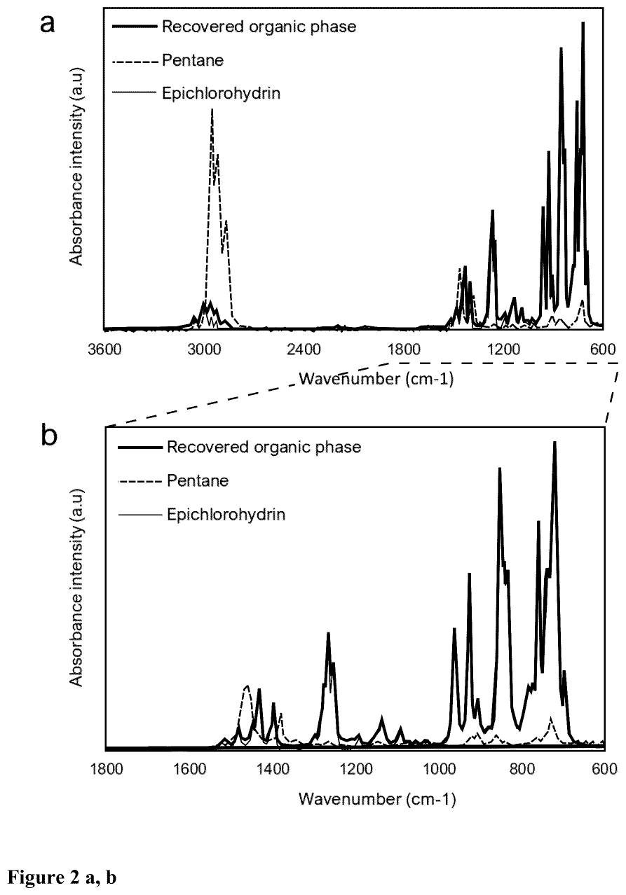

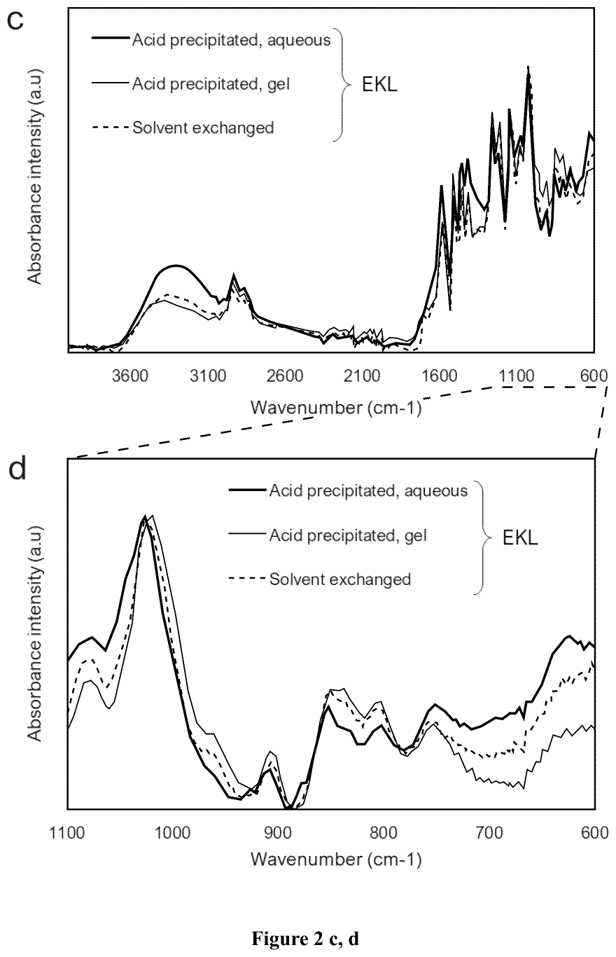

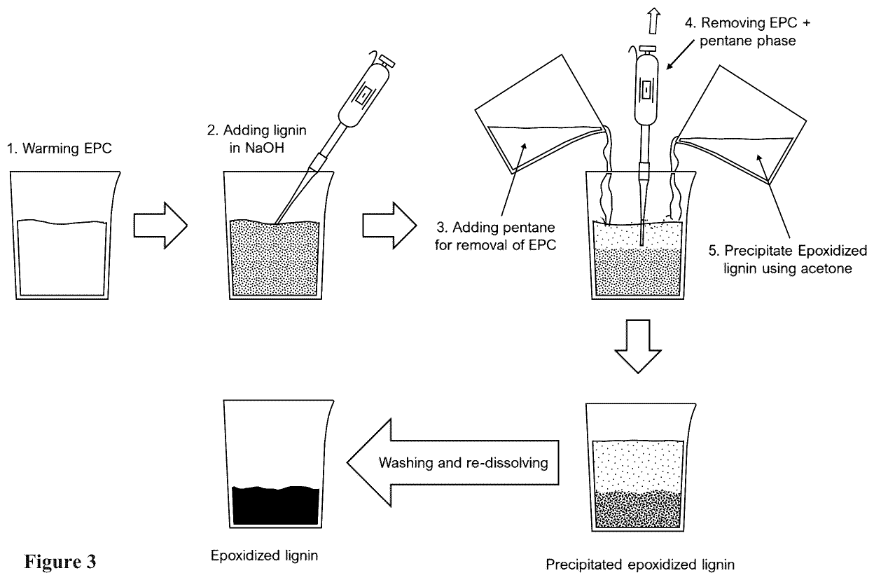

### EMBODIMENTS OF THE INVENTION

### Definitions

Epoxidized lignin (abbreviated EL) is defined as lignin modified through epoxidation using a process described in Embodiment 1. EL is in essence any type of lignin that has undergone a reaction that results in epoxy groups being grafted onto its hydroxyl groups, and may thus also be synthesized using other methods. Colloidal lignin particles (abbreviated CLPs, singular CLP) are defined as water-dispersible particles of lignin. CLPs are preferably prepared through the method described in WO2019081819A1. Nevertheless, CLPs are defined as micro- or nanosized particles of lignin that form stable suspensions or dispersions in water, and do not necessarily have to be prepared using any specific method. CLPs may not necessarily form stable dispersion in water after being dried fully. Hybrid CLPs are defined as CLPs containing some amount of another compound. The compound can be dispersed evenly within the particle or be concentrated in one part, e.g., the core of the particle. Surface-functionalized CLPs are CLPs onto the surface of which a compound has been either adsorbed (e.g. by electrochemical attraction) or covalently grafted.
Hardeners are defined as substances that may react with epoxies. Common hardeners are nucleophilic elements. Examples of suitable hardeners are amines (such as diethylenetriamine, triethylenetetramine, tetraethylenepentamine, N-aminoethylpiperazine, etc), polyols (preferably phenolic ones, such as lignin, bisphenol-A, novolacs, etc), or suitable thiols. Because CLPs can react with epoxies while maintaining their spherical morphology, they are also hardeners. Unmodified lignin is also a hardener. Active hardeners are here defined as hardeners that can react in ambient conditions within 24 h, while passive hardeners are here defined as hardeners that require activation, often in the form of heat or radiation. Passive hardeners are also defined as hardeners that may react sufficiently if given more than 24 h in ambient conditions. Steric hindrance is increased as the degree of curing is increased, which decreases the mobility of hardeners within the curing matrix. Some amount of hardener (active and passive) may never react in a matrix containing an equimolar amount of epoxide groups and hardening groups.
Curing is defined as the polymerization reaction between certain compounds, namely the epoxy compound and a hardener, to form larger networks of polymers that are often branched. EL should be cured to some extent to be effectively used in its final embodiment. The EL may be cured alone or with a hardener, depending on the pH and the epoxy/hydroxyl group ratio in the EL. If passive hardeners are used, curing may be performed using heat or radiation in the form of visible, infrared, or ultraviolet light. When using EL to adhere surfaces, pressing the adhered surfaces for 1-30 minutes at 50-200° C., preferably 3-7 minutes between 130-150° C., is sufficient to cure the EL. If preparing surface coatings or composites, strong light (with an energy of above 50 W/m², preferably above 100 W/m²) may also be suitable to initiate curing. All types of light may be referred to as radiation in this context. The curing time depends on the temperature, light-availability, light-penetration into the matrix, the water content, and the hardeners. Amine compounds (such as diethylenetriamine, triethylenetetramine, tetraethylenepentamine, N-aminoethylpiperazine) (active hardeners) are recommended when energy cannot be provided to initiate curing.

The present invention thus relates to a process for synthesising epoxidized lignin (EL), as well as to the use of the epoxidized lignin synthesized as described herein for adhesives, for composites, for coatings, or as a general cross-linker.

### Embodiment 1. The Synthesis of Epoxidized Lignin

One aspect of the invention is the synthesis of epoxidized lignin. The synthesis may use any lignin as raw material that:
1. is soluble in alkaline media, such as aqueous NaOH solutions.
2. has enough hydroxyl groups to undergo significant epoxidation, preferably at least 2 mmol/g, of which one third should preferably be phenolic or carboxylic.

Examples of suitable raw material is an industrial (technical) lignin, such as kraft lignin, organosolv lignin, alkali lignin, enzymatic lignin, hydrolysis lignin and the likes. Modified lignin, such as CLPs, fractionated, or depolymerized lignin are also suitable. Preferably, however, the raw material should not require any other modification than isolation (through commonly implemented industrial processes such as kraft or organosolv) and purification to the desired degree.

To start the process, a lignin solution is first prepared. Lignin is dissolved in NaOH or in another base. The concentrations are preferably 5-20 wt. % of lignin and 0.05-2 wt. % NaOH. Lower lignin concentrations can also be used but dilutes the final product. The lignin concentration may be up to 50 wt. % but increases the self-polymerization and decreases the solubility of the product. High concentrations of NaOH (25 wt. %) have shown the same effect. However, in cases where the amount of hydroxyl groups is exceptional (below 3 mmol/g or above 7 mmol/g), the upper and lower limits of the previously mentioned concentrations may be suitable. The lignin should be allowed to dissolve until no large aggregates are visible, as their presence results in increased self-polymerization.

The solution is then combined with epichlorohydrin while stirring. The amount of epichlorohydrin should preferably be 3-10 ml per gram of lignin. The mixture should be heated to at least 40-45° C. to initiate the epoxidation. The epichlorohydrin and/or the lignin solution may be heated prior to being mixed. The epichlorohydrin may be combined with the lignin by mixing them together all at once, or by gradual addition of the lignin to the epichlorohydrin.

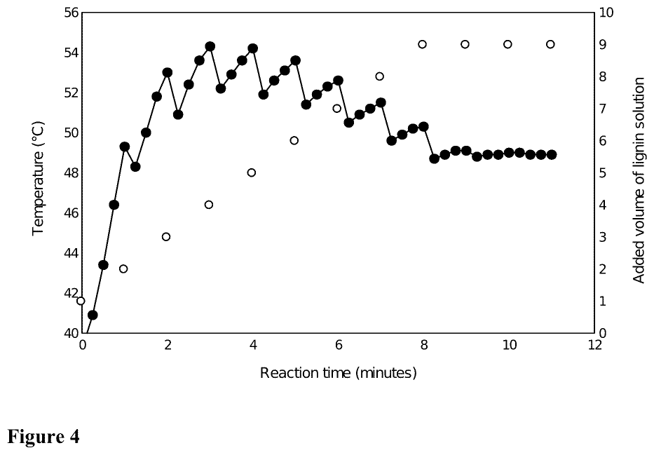

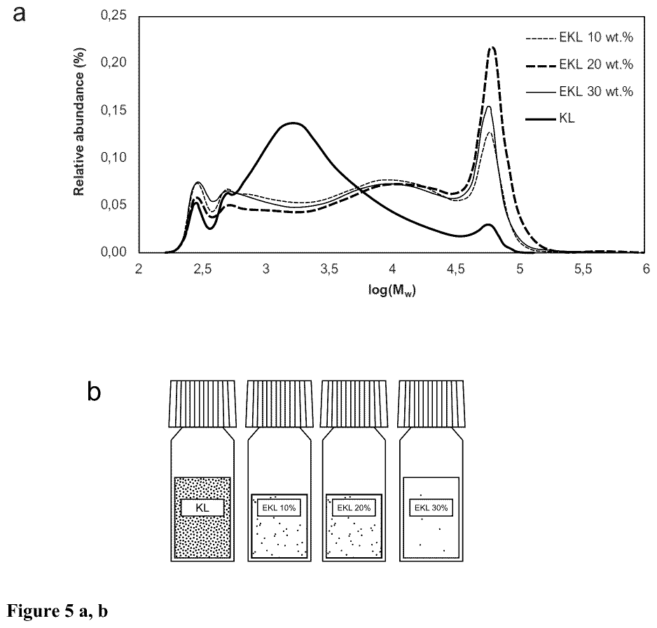

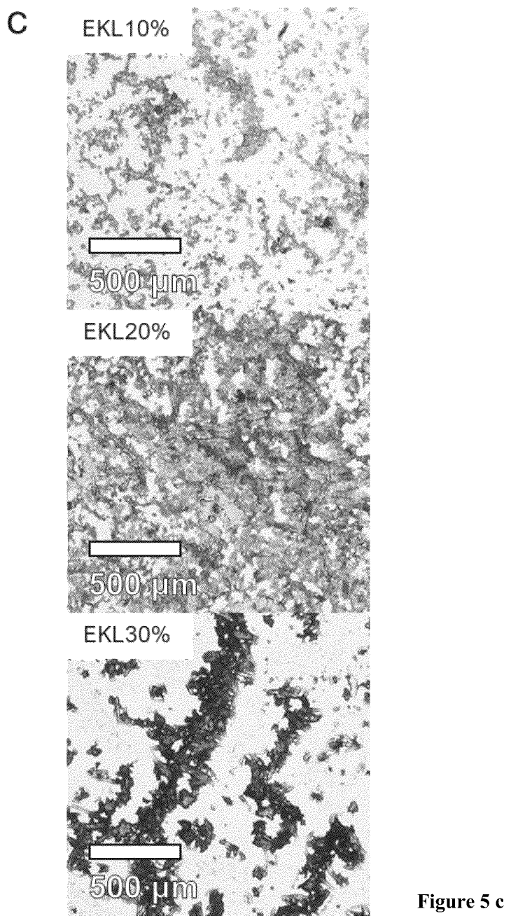

The reaction should be allowed to take place for 1 min-5 h, preferably 5-30 minutes, more preferably 8-15 minutes. The required duration depends on the temperature and the concentrations of the components. For example, when using 10 wt. % lignin solutions in 1 M NaOH (3.6 wt. % NaOH) and 7 ml epichlorohydrin per gram of lignin, 10-12 minutes of reaction produces a conversion of above 80 % when the temperature is allowed to gradually increase from 40-56° C. due to the exothermic reaction (FIG. 4).

When the epoxidation step is finished, the EL should be separated from the epichlorohydrin. This can be done using solvent extraction or ultrafiltering. If ultrafiltering is used as this point, the EL is also separated from the liquid and can be washed and purified immediately. If solvent extraction is used before ultrafiltering, the mixture may need cooling. Solvent extraction may be used by adding pentane, hexane, toluene, or other non-water-soluble solvent that is miscible in epichlorohydrin. The volume of the added organic solvent should preferably be at least as large as the volume of the used epichlorohydrin. The transparent organic phase, containing most of the epichlorohydrin, can be separated from the aqueous phase. The epichlorohydrin may be recovered from the extract solvent (e.g. pentane) by rotary evaporation or similar techniques.

If solvent extraction is used to separate the epichlorohydrin before ultrafiltering, the EL may be precipitated before being washed. To precipitate EL, an organic, water-soluble solvent, such as acetone or tetrahydrofuran, should be carefully added to the aqueous phase containing the EL. The required amount of organic solvent required for precipitation is 2-3 times the volume of the aqueous phase, depending on the molecular size of the EL. The precipitated EL may be separated from the liquid phase by e.g. decanting. The small amount of non-aggregated EL left suspended in the liquid phase may be recovered by ultrafiltration or centrifugation. Solvent precipitation works best at alkaline pH levels.

The EL may be washed with an organic solvent, such as acetone or pentane, or alternatively tetrahydrofuran, to remove any remaining epichlorohydrin. The EL may then be dried or re-dissolved in water. The pH may be adjusted by solvent exchange in an ultrafilter, by acid neutralization (e.g., using HCl), or by dialysis.

### Embodiment 2. The Use of Epoxidized Lignin for Adhesives

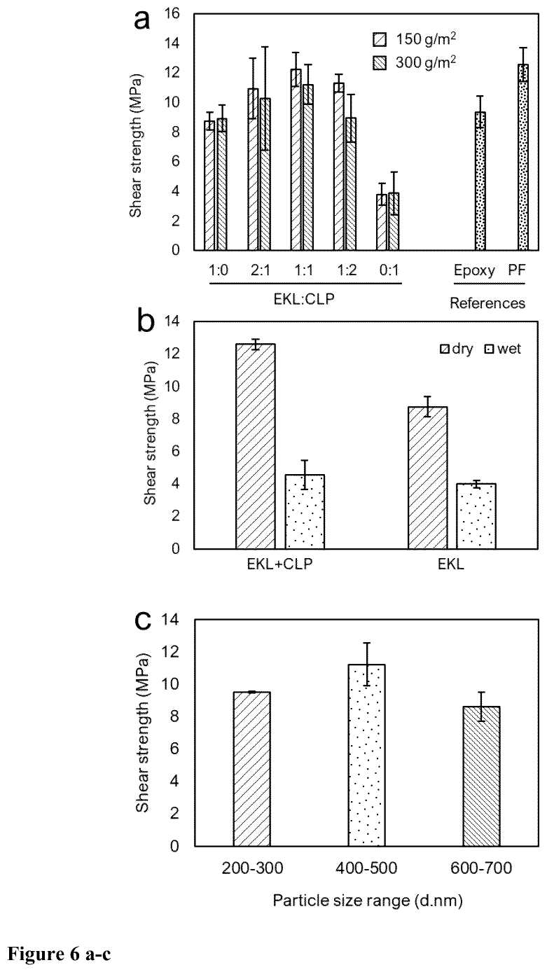

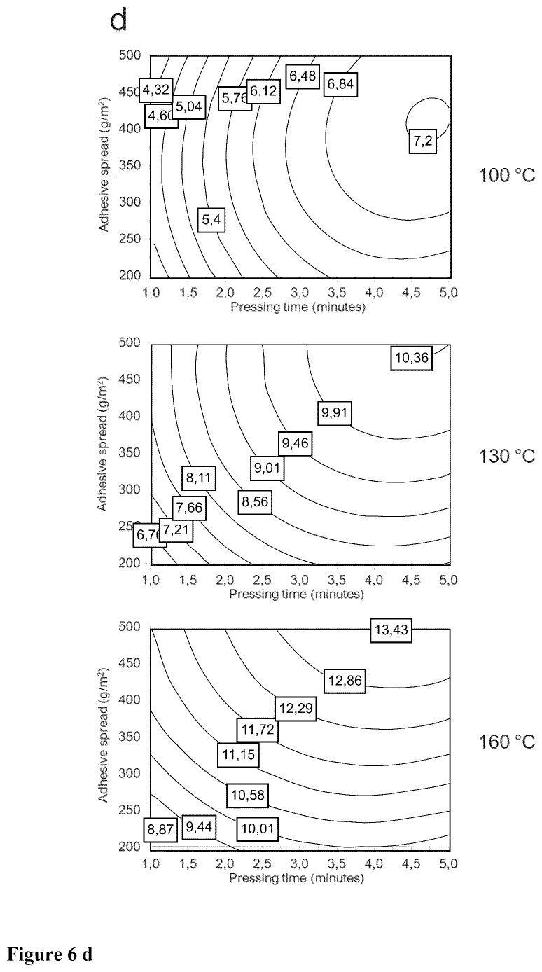

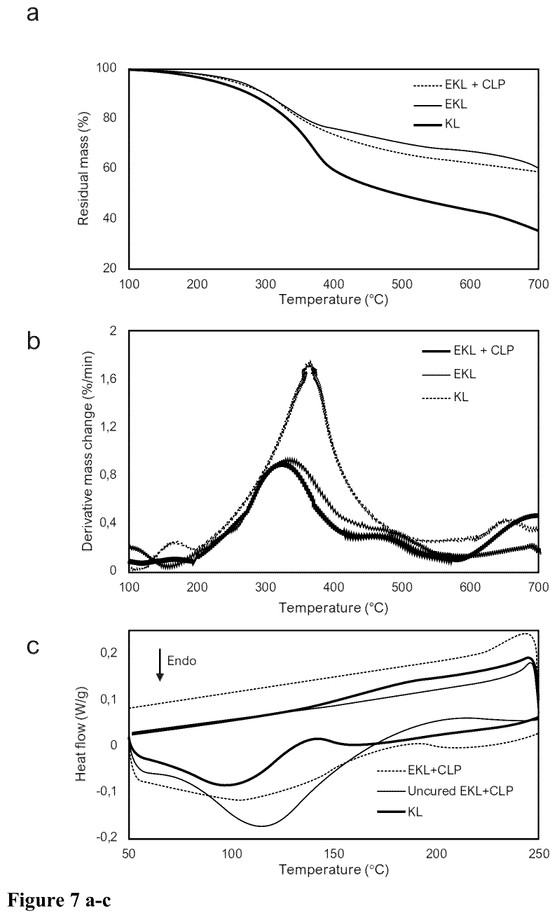

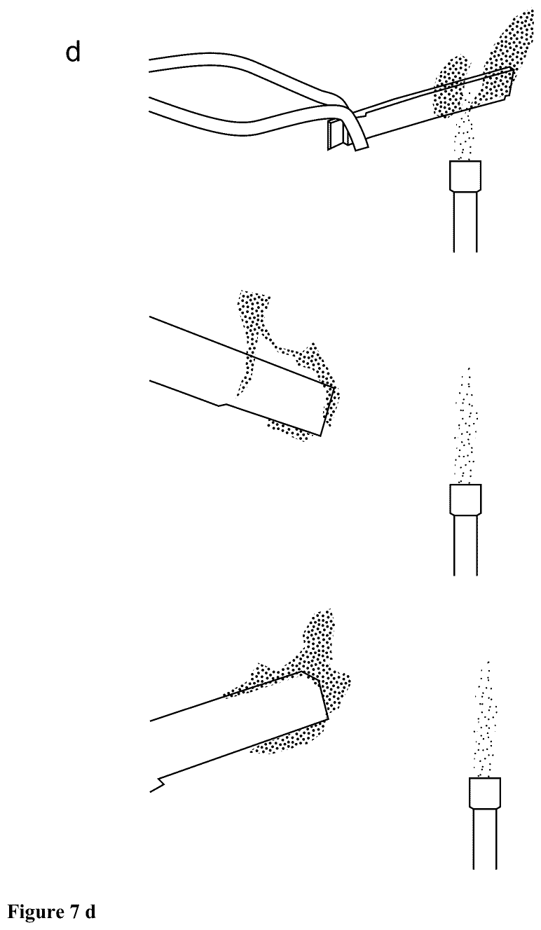

One aspect of the invention is the use of EL as binder, especially for wooden surfaces. EL can be used as adhesive in similar fashion as a phenol-formaldehyde type-resins are used. If EL is used without a hardener, EL is spread on the desired substrate, e.g. wood, metal, glass, and materials of the likes. Hot-pressing at 50-200° C., preferably 130-160° C. for 1-60 minutes, preferably 1-7 minutes, is recommended (data on the effect of these parameters in FIG. 6). The adhesive's concentration should be above 5 wt. %, preferably 30-45 wt. %, to reduce the chance of steam blowout. The adhesive spread should preferably be 50-200 g/m² but can be larger or smaller depending on the concentration and water content.

If CLPs are used as hardener they can be sprayed onto the substrate, preferably after EL has been spread. CLPs and EL can also be mixed beforehand. The concentration of the CLP dispersion can be adjusted according to the application, but a concentration above 20 wt. % is often beneficial to reduce the water content in the composition. Other hardeners (passive and active) can be used as well. The EL/hardener ratio should preferably be such, that the ratio of reactive groups (epoxide/hardener) is close to one. The hardening compounds may serve additional purposes, such as provide functionality like flexibility, UV-shielding, antimicrobial properties, etc. Other non-hardening additives, such as plasticizers, may be present.

EL can also be used in combination with other resins, e.g. formaldehyde-based resins. In that case, EL is combined and mixed with the resin. In resins where phenol or urea are used as monomers/hardeners, the amount of EL can be adjusted according to the phenolic hydroxyl groups and/or amide groups. For example, molar formaldehyde/phenol ratios in commercial resins are often 1.5-1.9 mol/mol. This ratio can be used but can also be slightly reduced if a higher amount of EL is used to compensate for the reduced amount of formaldehyde.

### Embodiment 3. The Use of Epoxidized Lignin for Coatings

One aspect of the invention is its use as surface coating. The EL is spread onto the surface, and then cured. Hardeners can be used as described in Embodiment 2. The EL may be cured using heat or radiation in the form of visible, infrared, or ultraviolet light. Methods for curing such as heat-lamination, calendering, or curing in an oven are also possible. As in Embodiment 2, EL can be mixed with other resins.

### Embodiment 4. The Use of Epoxidized Lignin for Composites

One aspect of the invention is the use of EL to cross-link elements in composites. EL can be used either dry or dissolved, depending on the hydrophilicity of the composite's matrix. Composites may be prepared by adding one or multiple hardener(s) (as described in Embodiment 2) to EL, in addition to possible reinforcing elements, such as fibers if so desired. The EL may be cured using heat, or radiation in the form of visible, infrared, or ultraviolet light.

### Embodiment 5. The Use of Epoxidized Lignin As a General Cross-Linker

One aspect of the invention is the use of EL as general cross-linker in varying applications. For example it can be used to cross-link CLPs in varying applications such as Pickering emulsions (Zou T. et al. 2019), thermal storage (Sipponen M H. et al. 2020), aerogels (Zhang X. et al. 2020), and other applications where solvent stability is required (Mattinen M L. et al. 2018), such as hydrogels. In such applications, EL can either be co-precipitated with unmodified lignin into hybrid lignin particles or combined with an aqueous dispersion containing lignin particles, such as a dispersion, a Pickering emulsion, a foam, a gel, etc., or lignin particles can be prepared from only EL using methods described in WO2019081819A1 and then used for applications as a particulate cross-linker. EL can also be used to cross-link other compounds with commercial hardeners (passive or active ones) for a broad range of applications applications.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. In addition, various embodiments and examples of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In this description, numerous specific details are provided to provide a thorough understanding of embodiments of the invention. One skilled in the relevant art will recognize, however, that the invention can be practiced without one or more of the specific details.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The following non-limiting examples are intended merely to illustrate the advantages obtained with the embodiments of the present invention.

### EXAMPLES

### Example 1. Synthesis of Epoxidized Kraft Lignin at 10 wt. % With Partial Addition

1 g kraft lignin is weighed and dissolved in 10 g 1 M NaOH. The lignin is allowed to dissolve by being stirred for at least 5 minutes. 7 ml epichlorohydrin is heated to 45° C. while being efficiently stirred. Then, 1 ml kraft lignin is added to the epichlorohydrin each minute until all of the lignin has been added to the epichlorohydrin. The temperature is allowed to increase due to the exothermic reaction until reaching 60° C. The reaction is stopped after 11 minutes. The majority of epichlorohydrin is removed by pentane solvent extraction. The pentane and epichlorohydrin is separated by distillation. The solution containing the EL is slowly added to 25 ml acetone and stirred very gently. The precipitated EL is separated from the acetone by decanting. The EL left suspended in the acetone is recovered by centrifugation or membrane filtration. The EL is dried or washed with water over a membrane and re-dissolved in clean water.

### Example 2. Synthesis of Epoxidized Kraft Lignin at 10 wt. % With All-at-Once Addition

1 g kraft lignin is weighed and dissolved in 10 g 1 M NaOH. The lignin is allowed to dissolve by being stirred for at least 5 minutes. 7 ml epichlorohydrin is heated to 45° C. while being efficiently stirred. Then, the kraft lignin solution is added to the epichlorohydrin. The temperature is allowed to increase due to the exothermic reaction until reaching 60° C. The reaction is stopped after 11 minutes. The majority of epichlorohydrin is removed by pentane solvent extraction. The pentane and epichlorohydrin is separated by distillation. The solution containing the EL is slowly added to 25 ml acetone and stirred very gently. The precipitated EL is separated from the acetone by decanting. The EL left suspended in the acetone is recovered by centrifugation or membrane filtration. The EL is dried or washed with water over a membrane and re-dissolved in clean water.

### Example 3. Synthesis of Epoxidized Kraft Lignin at 20 wt. % With Partial Addition

1 g kraft lignin is weighed and dissolved in 5 g 2 M NaOH. The lignin is allowed to dissolve by being stirred for at least 5 minutes. 7 ml epichlorohydrin is heated to 45° C. while being efficiently stirred. Then, 1 ml kraft lignin is added to the epichlorohydrin each minute until all of the lignin has been added to the epichlorohydrin. The temperature is allowed to increase due to the exothermic reaction until reaching 60° C. The reaction is stopped after 11 minutes. The majority of epichlorohydrin is removed by pentane solvent extraction. The pentane and epichlorohydrin is separated by distillation. The solution containing the EL is slowly added to 25 ml acetone and stirred very gently. The precipitated EL is separated from the acetone by decanting. The EL left suspended in the acetone is recovered by centrifugation or membrane filtration. The EL is dried or washed with water over a membrane and re-dissolved in clean water.

### Example 4. The Use of Epoxidized Lignin as Adhesive

A solution of EL with the concentration 40° C. wt. % is prepared as in Example 1. The EL is spread on wooden veneers with a spread of 200 g/m² between each adhesive joint. The veneers are combined and hot pressed at 145° C. for 5 minutes at 30 kN/m² or optionally 3 minutes at 30 kN/m², then at 1 minute at 30 kN/m², and 1 minute at 15 kN/m².

### Example 5. The Use of Epoxidized Lignin as Adhesive With CLPs

A solution of EL with the concentration 40 wt. % is prepared as in Example 1. The EL is spread on wooden veneers with a spread of 100 g/m² in each adhesive joint. An equal mass of a CLP dispersion with a concentration of 40 wt. % is evenly sprayed onto the veneers that contain a layer of EL. The veneers are combined and hot pressed at 145° C. for 5 minutes at 30 kN/m² or optionally 3 minutes at 30 kN/m², then at 1 minute at 30 kN/m², and 1 minute at 15 kN/m².

### Example 6. The Use of Epoxidized Lignin as Adhesive With Hybrid CLPs

CLPs are prepared as in WO2019081819A1 (35), but tall-oil fatty acid (TOFA) is dissolved together with the lignin, similarly to the process described by Sipponen et al (34). The concentration of lignin and TOFA is both 10 g/ml before particle-precipitation. The resulting particles are hybrid TOFA CLPs, referred to as hybrid CLPs. Other compounds that can be used to form hybrid particles with lignin can be used as well in a similar manner.

A solution of EL with the concentration 40 wt. % is prepared as in Example 1. The EL is spread on wooden veneers with a spread of 100 g/m² in each adhesive joint. An equal mass of a hybrid CLP dispersion with a concentration of 40 wt. % is evenly sprayed onto the veneers that contain a layer of EL. The veneers are combined and hot pressed at 145° C. for 5 minutes at 30 kN/m² or optionally 3 minutes at 30 kN/m², following a ramp-down in pressure, e.g., 1 minute at 20 kN/m², and 1 minute at 15 kN/m².

### Example 7. The Use of Epoxidized Lignin as Adhesive With Phenol-formaldehyde

A solution of EL (1.8 mmol epoxy groups per gram of EL) with the concentration 40 wt. % is prepared as in Example 1. The EL is mixed with an uncured dispersion of phenol-formaldehyde polymer with a concentration of 30-50 wt. % with a formaldehyde/phenol ratio of 1.9 mol/mol. The EL/phenol/formaldehyde mass ratio is 1.0:0.2:0.1. The adhesive contains 10 wt. % NaOH. The mixture is then spread on wooden veneers with a spread of 100 g/m² in each adhesive joint. The veneers are combined and hot pressed at 145° C. for 5 minutes at 30 kN/m² or optionally 3 minutes at 30 kN/m², then at 1 minute at 30 kN/m², and 1 minute at 15 kN/m².

### Example 8. The Use of Epoxidized Lignin as Surface Coating

EL is prepared as in Example 1. The concentration is adjusted to 30 wt. % and spread on a wooden surface with a spread of 50g/m². The EL is cured 20 minutes at 100° C. in an oven. This procedure can also be performed with the formulation presented in Example 7.

### Example 9. The Use of Epoxidized Lignin and Polyvinyl Alcohol for Composites With Glycerol as Softener

EL is prepared as in Example 1 or Example 2. The concentration of the EL solution is adjusted to 40 wt. %. Polyvinyl alcohol (PVA) and glycerol are mixed into the solution to achieve EL:PVA:glycerol mass ratios of 1:1:0.25. The material is dried and cured as a film at 100° C. in ambient pressure for 1 hour.

### Example 10. The Use of Epoxidized Lignin and Cellulose Nanofibrils for Composites With Glycerol as Softener

EL is prepared as in Example 1 or Example 2. The concentration of the EL solution is adjusted to 40 wt. %. Cellulose nanofibrils (CNF) and glycerol are mixed into the solution to achieve EL:CNF:glycerol mass ratios of 1:1:0.25. The material is dried and cured as a film at 100° C. in ambient pressure 1 h.

### Example 11. The Use of Epoxidized Lignin in Composites With Cellulose Nanofibrils and CLPs

EL is prepared as in Example 1 or Example 2. The concentration of the EL solution is adjusted to 40 wt. %, and the pH is adjusted to 8. Cellulose nanofibrils (CNF) and CLPs are mixed into the solution to achieve EL:CNF:CLP mass ratios of 1:2:1. The material is dried and cured as a film at 100° C. in ambient pressure 1 h.

### INDUSTRIAL APPLICABILITY

The present process can be used to prepare an epoxidized lignin material that is particularly suitable for use as can be used as adhesives, composites, coatings, or as general cross-linkers, and generally for replacement of formaldehyde in conventional similar products.

### CITATION LIST

1. Rafiqul I, Weber C, Lehmann B, Voss A. Energy efficiency improvements in ammonia production-Perspectives and uncertainties. Energy. 2005; 30(13).
2. Gentry JC. Benzene production and economics: A review. Vol. 2, Asia-Pacific Journal of Chemical Engineering. 2007.
3. Bastin JF, Finegold Y, Garcia C, Mollicone D, Rezende M, Routh D, et al. The global tree restoration potential. Science (80-). 2019; 364(6448).
4. Heinrich LA. Future opportunities for bio-based adhesives-advantages beyond renewability. Vol. 21, Green Chemistry. 2019.
5. Hochwalt C, Mark P. Production of phenol-aldehydelignin resins [Internet]. US; U.S. Pat. No. 2,168,160A, 1936. Available from: https://patents.google.com/patent/US2168160A/en?q=phenol+formaldehyde+lignin+resin&oq=phenol+formaldehyde+lignin+resin&sort=old
6. Novotny E, Romieux C. Synthetic resin and method of making same [Internet]. US; U.S. Pat. No. 1,886,353A, 1922. Available from: https://patents.google.com/patent/US1886353A/en
7. Kai D, Tan MJ, Chee PL, Chua YK, Yap YL, Loh XJ. Towards lignin-based functional materials in a sustainable world. Green Chem. 2016; 18(5):1175-200.
8. Ludwig C, Stout A. Plywood process and product wherein the adhesive comprises a lignosulfonate-phenol-formaldehyde reaction product [Internet]. US; U.S. Pat. No. 3,658,638A, 1970. Available from: https://patents.google.com/patent/US20200040022A1/en?q=UPM%2C+lignin%2C+phenol%2C+plywood+adhesive&oq=UPM%2C+lignin%2C+phenol%2C+plywood+adhesive&sort=new
9. Pietarinen S, Valkonen S, Ringena O. Method for treating lignin and for producing a binder composition [Internet]. Finland; 2013. Available from: https://patents.google.com/patent/US20200040022A1/en?q=UPM%2C+lignin%2C+phenol%2C+plywood+adhesive&oq=UPM%2C+lignin%2C+phenol%2C+plywood+adhesive&sort=new
10. Doering G. Lignin modified phenol-formaldehyde resins [Internet]. US; U.S. Pat. No. 5,202,403A, 1992. Available from: https://patents.google.com/patent/US5202403A/en
11. Kalami S, Arefmanesh M, Master E, Nejad M. Replacing 100% of phenol in phenolic adhesive formulations with lignin. J Appl Polym Sci. 2017; 134(30).
12. McVay T, Baxter G, Dupre F. Reactive phenolic resin modifier [Internet]. US; U.S. Pat. No. 5,866,642A, 1992. Available from: https://patents.google.com/patent/US5866642A/en?q=phenol+formaldehyde+plywood+resin&oq=phenol+formaldehyde+plywood+resin
13. Kim KH, Jahan SA, Lee JT. Exposure to formaldehyde and its potential human health Hazards. J Environ Sci Heal-Part C Environ Carcinog Ecotoxicol Rev. 2011; 29(4):277-99.
14. Jurvelin JA, Edwards RD, Vartiainen M, Pasanen P, Jantunen MJ. Residential indoor, outdoor, and workplace concentrations of carbonyl compounds: Relationships with personal exposure concentrations and correlation with sources. J Air Waste Manag Assoc [Internet]. 2003 [cited 2021 Jun 11]; 53(5):560-73. Available from: https://www.tandfonline.com/action/journalInformation?ournalCode=uawm20
15. Kurttio P. et al. Chromosome aberrations in peripheral lymphocytes of workers employed in the plywood industry on JSTOR [Internet], Vol. 19, No. 2 (April 1993), pp. 132-134. [cited 2021 Jun 11]. Available from: https://www.jstor.org/stable/40966125?seq=1#metadata_info_tab_contents
16. McGwin G, Lienert J, Kennedy JI. Formaldehyde exposure and asthma in children: A systematic review [Internet]. Vol. 118, Environmental Health Perspectives. 2010 [cited 2021 Jun 11]. p. 313-7. Available from: http://dx.doi.org/
17. Saul Elbein: Will the skyscrapers of the future be made out of wood? [Internet] published January 13, 2020. [cited 2021 Mar 15]. Available from: https://www.nationalgeographic.com/science/article/skyscrapers-of-the-future-will-be-made-out-of-wood
18. Salazar J, Meil J. Prospects for carbon-neutral housing: the influence of greater wood use on the carbon footprint of a single-family residence. J Clean Prod. 2009 Nov 1; 17(17):1563-71.
19. YIT Corporation. Wood becomes more popular in the construction of apartment buildings—the majority of the environmental impact of buildings is created during use [Internet]. 2021. Available from: https://news.cision.com/yit-oyj/r/wood-becomes-more-popular-in-the-construction-of-apartment-buildings---the-majority-of-the-environme,c3329808
20. Qian Y, Qiu X, Zhu S. Lignin: A nature-inspired sun blocker for broadspectrum Sunscreens. Green Chem. 2015; 17(1):320-4.
21. Vandenberg LN, Hauser R, Marcus M, Olea N, Welshons W V. Human exposure to bisphenol A (BPA). Vol. 24, Reproductive Toxicology. 2007. p. 139-77.
22. Rochester JR, Bolden AL. Bisphenol S and F: A systematic review and comparison of the hormonal activity of bisphenol a substitutes. Environmental Health Perspectives. 2015.
23. Malutan T, Nicu R, Popa VI. Lignin modification by epoxidation. BioResources. 2008; 3(4):1371-6.
24. Asada C, Basnet S, Otsuka M, Sasaki C, Nakamura Y. Epoxy resin synthesis using low molecular weight lignin separated from various lignocellulosic materials. Int J Biol Macromol. 2015; 74:413-9.
25. Sasaki C, Wanaka M, Takagi H, Tamura S, Asada C, Nakamura Y. Evaluation of epoxy resins synthesized from steam-exploded bamboo lignin. Ind Crops Prod. 2013; 43(1):757-61.
26. Ferdosian F, Yuan Z, Anderson M, Xu C. Synthesis of lignin-based epoxy resins: Optimization of reaction parameters using response surface methodology. RSC Adv [Internet]. 2014 Jul 21 [cited 2021 Jun 11]; 4(60):31745-53. Available from: www.rsc.org/advances
27. Zafar A, Areskogh D. A composition comprising lignin and epoxy compound for coating and method for manufacturing thereof and use thereof. WO2015044893 (A1), 2016. p. 7.
28. Jablonskis A, Arshanitsa A, Arnautov A, Telysheva G, Evtuguin D. Evaluation of Ligno Boost™ softwood kraft lignin epoxidation as an approach for its application in cured epoxy resins. Ind Crops Prod. 2018 Feb 1; 112:225-35.
29. Ferdosian F, Yuan Z, Anderson M, Xu CC. Chemically Modified Lignin through Epoxidation and its Thermal Properties. J-for [Internet]. 2012 [cited 2021 Jun 11]; 2:11-5. Available from: https://www.researchgate.net/publication/277292747_Chemically_Modified_Lignin_through_Epoxidation_and_its_Thermal_Properties
30. A kind of lignin-base adhesive for polyurethane of epoxidation modification. 2019 Jul 19, CN110343496A;
31. [symbol] [symbol] [symbol] , et al. Waterproof lignin-based epoxy resin adhesive and preparation method thereof [Internet]. China; CN112126391A, 2020. Available from: https://patents.google.com/patent/CN112126391A/en?oq=CN112126391A
32. Takahash A, Oyama T, Kono T, Tsunoda T. Purified lignin and epoxy resin [Internet]. Japan; JP2012236811A, 2011. Available from: https://patents.google.com/patent/JP2012236811A/en?oq=JP2012236811A
33. Henn KA, Österberg M, Forsman N. Lignin Nanoparticles and Epoxies for the Preparation of Durable and Highly Bio-Based Surface Coatings and Adhesives. [Espoo]: Aalto University; 2020.
34. Sipponen MH, Henn A, Penttilä P, Österberg M. Lignin-fatty acid hybrid nanocapsules for scalable thermal energy storage in phase-change materials. Chem Eng J. 2020; 393.
35. Lintinen K, Bangalore Ashok RP, Leskinen T, Xiao Y, Österberg M, Kostiainen M, et al. Aqueous lignin dispersions and methods of preparing the same. Finland; WO 2019081819(A1), 2018.
36. Zou T, Sipponen MH, Österberg M. Natural shape-retaining microcapsules with shells made of chitosan-coated colloidal lignin particles. Front Chem. 2019; 7(MAY):370.
37. Zhang X, Morits M, Jonkergouw C, Ora A, Valle-Delgado JJ, Farooq M, et al. Three-Dimensional Printed Cell Culture Model Based on Spherical Colloidal Lignin Particles and Cellulose Nanofibril-Alginate Hydrogel. Biomacromolecules. 2020; 21(5):1875-85.
38. Mattinen ML, Valle-Delgado JJ, Leskinen T, Anttila T, Riviere G, Sipponen M, et al. Enzymatically and chemically oxidized lignin nanoparticles for biomaterial applications. Enzyme Microb Technol. 2018; 111:48-56.

1. A process for synthesising epoxidized lignin (EL) comprising:
dissolving a lignin raw material comprising lignin in an aqueous solution of a base,
combining the lignin solution with epichlorohydrin at 1-90° C. while stirring, heating the mixture to at least 40° C. to initiate an epoxidation reaction, and allowing the epoxidation reaction to take place for 1 min-5 h to produce a solution of epoxidized lignin, and
removing excess epichlorohydrin from the solution of epoxidized lignin by solvent extraction or ultrafiltering, and optionally separately separating the epoxidized lignin from the solution of epoxidized lignin.

2. The process of claim 1, wherein the lignin raw material is an industrial or technical lignin selected from the group consisting of kraft lignin, organosolv lignin, alkali lignin, enzymatic lignin, hydrolysis lignin, a modified lignin, colloidal lignin particles (CLPs), and fractionated, or depolymerized lignin.

3. The process of claim 1, wherein the lignin raw material is selected from lignins containing more than 4 mmol/g hydroxyl groups.

4. The process of claim 1, wherein the lignin solution has a lignin concentration of 5-20 wt. % and an NaOH concentration of 0.05-2 wt. %.

5. The process of claim 1, wherein the lignin is dissolved in the aqueous solution of the base until no large aggregates are visible.

6. The process of claim 1, wherein the lignin solution is combined with the epichlorohydrin, wherein the amount of epichlorohydrin ef is 3-10 ml per gram of the lignin.

7. The process of claim 1, wherein the epichlorohydrin and/or the lignin solution is heated prior to combining them.

8. The process of claim 1, wherein the epoxidation reaction is allowed to take place for 5-30 minutes.

9. The process of claim 1, wherein the excess epichlorohydrin is removed from the epoxidized lignin solution by ultrafiltering, whereby the epoxidized lignin is simultaneously also separated from the liquid.

10. The process of claim 1, wherein the excess epichlorohydrin is removed from the epoxidized lignin solution by solvent extraction, by adding non-water-soluble extract solvent that is miscible in epichlorohydrin, in a volume that is at least as large as the volume of the excess epichlorohydrin.

11. The process of claim 10, wherein an organic phase, obtained after solvent extraction, is separated from an aqueous phase, and wherein the epichlorohydrin is recovered from the extract solvent.

12. The process of claim 1, wherein solvent extraction is used to separate the epichlorohydrin from the epoxidized lignin solution before ultrafiltering.

13. The process of claim 1, wherein the epoxidized lignin is separated from the solution of epoxidized lignin using an ultrafilter or by precipitation, wherein the precipitation is done by the addition of an organic solvent to the a solution of epoxidized lignin in an amount of organic solvent that is 2-3 times the volume of the solution of epoxidized lignin.

14. The process of claim 1, wherein the epoxidized lignin separated from the solution of epoxidized lignin is washed with an organic solvent to remove any remaining epichlorohydrin.

15. The process of claim 1, wherein the epoxidized lignin is dried or re-dissolved in water, and optionally the pH is adjusted by solvent exchange in an ultrafilter, by acid neutralization, or by dialysis.

16-21. (canceled)

22. The process of claim 1, wherein the process comprises separately separating the epoxidized lignin from the solution of epoxidized lignin.

23. The process of claim 1, wherein the lignin raw material comprises colloidal lignin particles (CLPs), and fractionated, or depolymerized lignin.

24. The process of claim 3, wherein the lignins containing more than 4 mmol/g hydroxyl groups comprise at least 1 mmol/g phenolic hydroxyl groups.

25. A process for synthesising epoxidized lignin comprising:
dissolving a lignin raw material comprising lignin in an aqueous solution of a base;
combining the lignin solution with epichlorohydrin; and
heating the mixture to a temperature of at least 40° C. for an amount of time effective to produce a solution of epoxidized lignin.
